(19) United States
(12) Patent Application Publication
(10) Pub. No.: US 2011/0303516 A1
(43) Pub. Date: Dec. 15, 2011

(54) Electrical Switch Assembly with Pivoting Actuator

(75) Inventors: Albert Beyginian, Aurora (CA); Ronald K. Finlay, Etobicoke (CA); Christopher Larsen, Toronto (CA)

(73) Assignee: OMRON DUALTEC AUTOMOTIVE ELECTRONICS INC., Oakville (CA)

(21) Appl. No.: 13/153,109

(22) Filed: Jun. 3, 2011

Related U.S. Application Data
(60) Provisional application No. 61/354,783, filed on Jun. 15, 2010.

(51) Int. Cl. H01H 13/02; H01H 21/02

(52) U.S. Cl. 200/337

(57) ABSTRACT

An electrical switch assembly comprising: a housing; an actuation button supported by the housing, the actuation button having one or more downward extensions, each having an arcuate tip; an electrical circuit contained in the housing; an elastomeric pad comprising a collapsible dome overlying the electrical circuit; and one or more pivoting actuators pivotally supported in the housing between the tip and the dome, the pivoting actuator comprising a shoulder to engage the tip during movement of the actuation button to cause the pivoting actuator to collapse an underlying one of the domes.

This application claims priority to U.S. Provisional Patent Application No. 61/354,783, filed on Jun. 15, 2010, the contents of which are incorporated herein by reference.

### TECHNICAL FIELD

The following relates to electrical switches and in particular to the actuation of such switches.

### BACKGROUND

It is often desirable that switches activated by a user in automotive and other applications provide a tactile feedback to enable the user to discern between different switching stages and/or functions. In this way, the user experiences changes in force during operation of the switch that provide feedback to the user as to the state of the switch.

For example, when the switch is activated, the user may first feel an increasing resistive force, and then a drop in force as the actuator stops in a first discernible position that indicates to the user that the switch is electrically activated. This first position is often referred to as the first detent. The switch may also provide a similar first detent when moving the actuator in the opposite direction. Some switches also provide a secondary function such as in automobile window switches, which are configured to provide an “Auto-down”, “Express-down” or “One-touch down” option for the window. To activate this type of option, the user pushes the switch actuator down beyond the first detent (or by pulling up for an “Auto-up” option) to a second discernible position or second detent. In this example, therefore, the switch can be pushed or pulled to its first or second detents for two separate functions (in this case window down/window express down or window up/window express up). The pushing and pulling of a switch in this way may also be referred to as operating or actuating the switch.

Two basic designs are prevalent for providing such tactile feedback, one is a spring-based tactile mechanism with separate electrical switching elements, and the other is a silicone rubber based membrane or elastomeric pad, often referred to as an “e-pad”, which provides tactile response and electrical switching when interfaced with a printed circuit board (PCB). An extension of the e-pad approach is a dome within a dome, referred to as a double detent dome. While this double detent dome approach addresses some packaging and component count aspects of the product, all of these designs may suffer from limitations in force, travel, package size, and performance variations.

### SUMMARY

In one aspect, there is provided an electrical switch assembly comprising: a housing; an actuation button supported by the housing, the actuation button having a first downward extension; an electrical circuit contained in the housing; an elastomeric pad comprising a collapsible dome overlying the electrical circuit; and a first pivoting actuator supported in the housing between the first downward extension and the dome, the first pivoting actuator comprising a first end pivotally connected to the housing, a second end aligned with an upper surface of the dome, and a shoulder between the first and second ends and aligned with the first downward extension to be operated on by the first downward extension during a first movement of the actuation button to cause the second end of the first pivoting actuator to collapse the first dome to activate the electrical circuit.

In another aspect, the electrical assembly outlined above further comprises a second pivoting actuator supported in the housing between a second downward extension of the actuation button and a second collapsible dome spaced from the first collapsible dome, the second pivoting actuator comprising a first end pivotally connected to the housing, a second end aligned with an upper surface of the second collapsible dome, and a shoulder between the first and second ends of the second pivoting actuator and aligned with the second downward extension to be operated on by the second downward extension during a second movement of the actuation button to cause the second end of the second pivoting actuator to collapse the second dome to activate the electrical circuit.

In yet another aspect, there is provided a pivoting actuator for actuating a collapsible dome in an electrical switch assembly, the pivoting actuator comprising: at least one attachment post at a first end for pivotally connecting the pivoting actuator to a housing of the electrical switch assembly; a first arm extending from the at least one attachment post to a second end aligned with an upper surface of the dome; and a shoulder between the first and second ends and aligned with a first downward extension from an actuation button of the electrical switch assembly to be operated on by the first downward extension during a first movement of the actuation button to cause the second end of the pivoting actuator to collapse the dome and activate the electrical circuit.

### BRIEF DESCRIPTION OF THE DRAWINGS

Embodiments will now be described by way of example only with reference to the appended drawings wherein:

FIG. 1 is a pictorial view of a portion of the interior of an automobile comprising a set of electrical switch assemblies.

FIG. 2 is a perspective view of an electrical switch assembly in isolation.

FIG. 3 is an exploded perspective view of the electrical switch assembly of FIG. 2.

FIG. 4 is a perspective view of a set of pivoting actuators and an underlying elastomeric pad (e-pad) in isolation.

FIG. 5 is a cross-sectional view of the pivoting actuators and e-pad of FIG. 4 along line A-A.

FIG. 6 is an elevation view of an actuator button.

FIG. 7 is a cross-sectional view of the pivoting actuators and e-pad of FIG. 4 along line B-B.

FIG. 8 is a perspective view showing a pivoting actuator and plunger assembly in isolation.

FIG. 9 is a perspective view showing a plunger assembly in isolation.

FIG. 10 is a perspective view showing a pivoting actuator in isolation.

FIG. 11 is a perspective view showing another embodiment of the pivoting actuator.

FIG. 12 is a cross-sectional view illustrating activation of a pivoting actuator.

FIG. 13 is a partial cross-sectional view of an electrical switch assembly at rest.

FIG. 14 is a cross-sectional view of an e-pad at rest.

FIG. 15 is a partial cross-sectional view of the electrical switch assembly at the onset of collapsing a first flexible wall.

FIG. 16 is a cross-sectional view of the e-pad at the onset of collapsing the first flexible wall.

FIG. 17 is a partial cross-sectional view of the electrical switch assembly upon collapsing the first flexible wall.

FIG. 18 is a cross-sectional view of the e-pad upon the first flexible wall collapsing showing an outer dome member making contact with an underlying PCB.

FIG. 19 is a cross-sectional view of the e-pad showing the onset of over-travel of the first flexible wall.

FIG. 20 is a partial cross-sectional view of the electrical switch assembly at the onset of collapsing a second flexible wall.

FIG. 21 is a cross-sectional view of the e-pad showing the onset of collapsing the second flexible wall.

FIG. 22 is a partial cross-sectional view of the electrical switch assembly upon collapsing the second flexible wall.

FIG. 23 is a cross-sectional view of the e-pad upon the second flexible wall collapsing showing an inner dome member making contact with the underlying PCB.

FIG. 24 is a cross-sectional view of the e-pad showing over-travel on the second flexible wall.

FIG. 25 shows a force/displacement response curve corresponding to various actuation positions.

FIG. 26 provides a pictorial view of an actuator button illustrating a rest position, two up, and two down positions corresponding to the actuation positions in FIG. 25.

FIG. 27 provides a detailed view of the force/displacement response curve of FIG. 25.

FIG. 28 provides a detailed view of the force/displacement response curve along with a return stroke profile.

FIG. 29 is an enlarged elevation view showing an over-protection mechanism.

FIG. 30 is a perspective view of the electrical switch assembly showing the over-protection mechanism.

FIG. 31 is a cross-sectional view of an e-pad in a single detent embodiment in one direction.

FIG. 32 is a cross-sectional view of the e-pad in the single detent embodiment in another direction.

FIG. 33 provides a force/displacement graph associated with the single detent profile version of the electrical switch assembly.

FIGS. 34 and 35 illustrate an example reduction in package size utilizing the principles discussed below.

FIGS. 36 to 38 illustrate example calculations showing a force multiplier effect using the principles discussed below.

FIGS. 39 and 40 illustrate two example result sets with different inputs to the calculations shown in FIGS. 36-38.

### DETAILED DESCRIPTION OF THE DRAWINGS

The following provides a pivoting actuator for actuating an electrical switch that enables the provision of a wider range of tactile profiles (force and travel) with coordinated electro-mechanical timing, using fewer components, with less sensitivity to variation of the components, while offering high durability and reliability in a relatively small package size.

It has been found that, unlike straight line plungers, a pivoting actuator as described herein can be used to act as a lever and thus take advantage of mechanical ratios to create higher tactile efforts reflected back to the user when interacting with the actuation button of the switch assembly, while enabling both single and dual actuation configurations in either or both directions. The mechanical ratio enables changes to the tactile profile of the switch assembly to be made without changing the characteristics of an e-pad operated on by the pivoting actuator, thus avoiding potentially costly modifications when variations in the tactile response are desired.

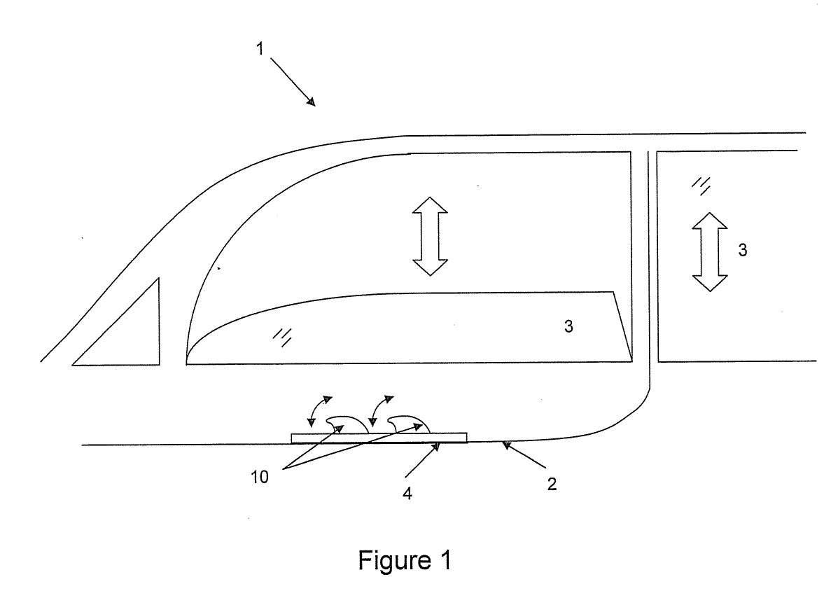

Turning now to FIG. 1, a switch panel 4 is shown, which comprises a set of electrical switch assemblies 10. In this example, the switch panel 4 is integrated into a door console 2 of an automobile 1 and the electrical switch assemblies 10 are used to operate door windows 3. Each switch assembly 10 corresponds to a particular window 3 and in this example, a set of four electrical switch assemblies 10 is used to operate two front windows 3 and two rear windows 3 as is well known in the art. It will be appreciated that the use of the switch assemblies 10 in an automotive application is only one example and various other uses are applicable as will be apparent from the following description.

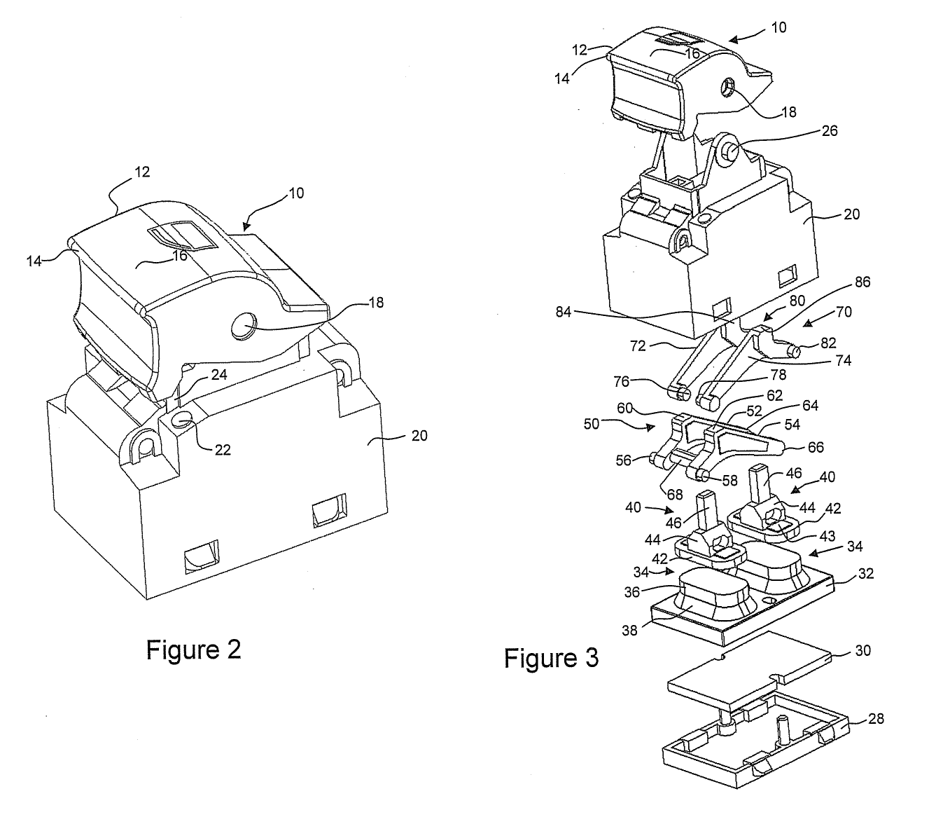

FIG. 2 shows an enlarged perspective view of a switch assembly 10 in isolation. The switch assembly 10 comprises an actuation button 12, which in this example is a knob or rocker style member providing limited linear or rotary movement, respectively, and which can be actuated through rotation about an axis defined by attachment points 18 and protruding elements 26 on a housing 20 (see also FIG. 3). The actuation button 12 comprises a broad upper surface 16 which can be pressed “down” thus rocking the actuation button 12 in a “forward” direction. The actuation button 12 also comprises a lip 14 (or other protrusion) at the end of the upper surface 16 enabling the actuation button 12 to be “pulled” up thus rocking the actuation button 12 back in direction opposite that of the forward direction. The housing 20 is used to contain, guide, and support the various components of the switch assembly 10. The housing 20 may be a separate component as shown in FIG. 2 or may be integrated with other assemblies via the panel 4 or door console 2 shown in FIG. 1. It will be appreciated that the housing 20 shown in FIG. 2 is for illustrative purposes only.

FIG. 3 provides an exploded perspective view of the switch assembly 10. From the exploded view, it can be seen that the housing 20 encloses the various components of the switch assembly 10 using a base closure 28. The closure 28 supports a PCB 30, which in turn supports an e-pad 32. The e-pad 32 comprises in this example front and rear dome structures 34, each comprising flexible outer walls 38 supporting planar actuation stages 36. As will be shown in greater detail in FIG. 14, each dome structure 34 provides two successive actuation stages using inner and outer domes 104, 108, 112.

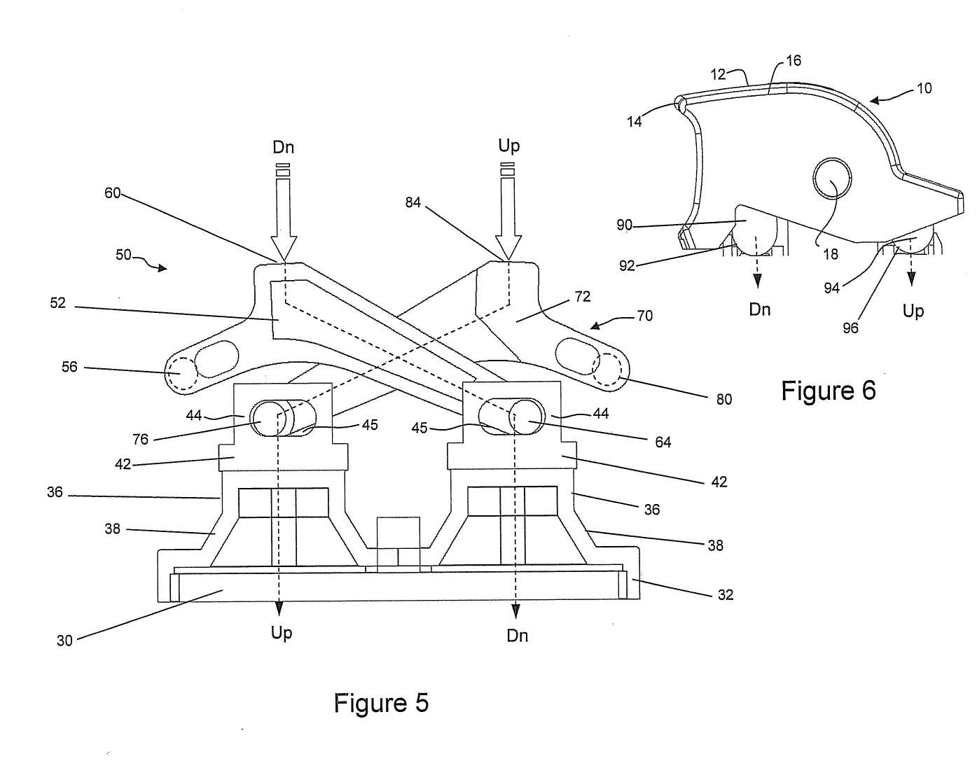

Each actuation stage 36 supports a corresponding plunger 40. Each plunger 40 comprises a base 42 which, in this example is similarly sized to the actuation stage 36. A centrally located attachment portion 44 extends upwardly from the base 42 and comprises an attachment slot 45 on each side (see also FIG. 5). A guide post 46 extends upwardly from the attachment portion 44 and cooperates with the housing 20 to guide vertical movement of the plunger 40 during its actuation and return to rest. The guide posts 46 are used to inhibit lateral movement of the plunger 40 with respect to its underlying dome structure 34 to thereby minimize shear forces imparted on the flexible walls 38, which can contribute to shorter life cycles if not controlled. The actuation stage 36 extends from either side of the attachment portion to provide upwardly facing actuation surfaces 43. The actuation surfaces 43 interact with pivoting actuators 50, 70 to collapse the underlying dome structures 34 as will be explained in greater detail later.

From the view provided in FIG. 3, it can be seen that the actuation button 12 is supported atop the housing 20 using a pair of upstanding supports that provide protruding elements 26 that interact with corresponding apertures 18 in opposite sidewalls of the actuation button 12. The actuation button 12 includes a pair of extensions 90, 94 (see also FIG. 6) that each protrude downwardly through an aperture or opening provided in the housing 20, which permits the extensions 90, 94 to extend into the interior of the housing 20 for interacting with the pivoting actuators 50, 70. The extensions 90, 94 move conjointly with the actuation button 12 such that “pushing” the actuation button 12 causes a forward extension 90 to actuate the front dome structure 34 and “pulling” the actuation button 12 causes a rearward extension 94 to actuate the rear dome structure 34. The interior of the housing 20 is configured to allow limited rotational movement, but to restrict fore/aft movements of the pivoting actuators 50, 70, while permitting vertical movement of the plungers 40 which are constrained by the guide posts 46 and associated housing 20 contours to enable the plungers 40 to operate on, and linearly collapse the dome structures 34 as discussed above.

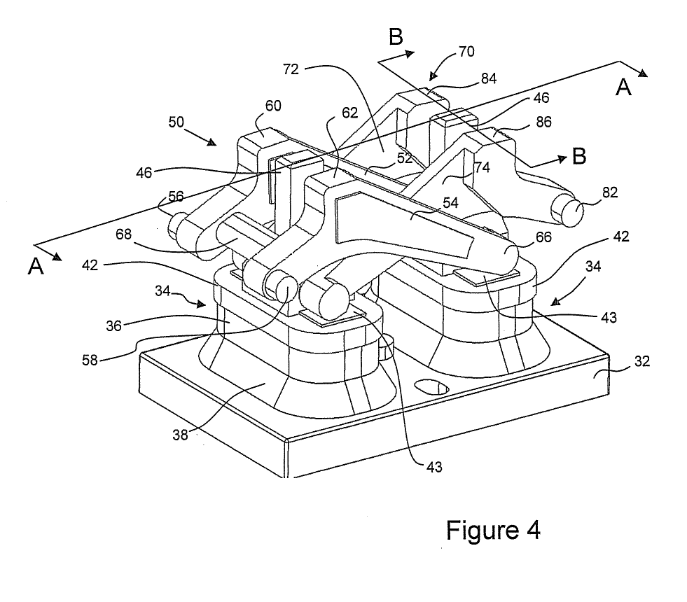

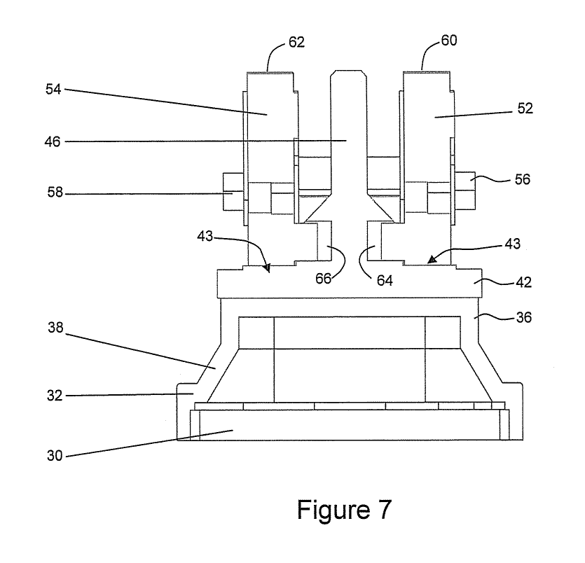

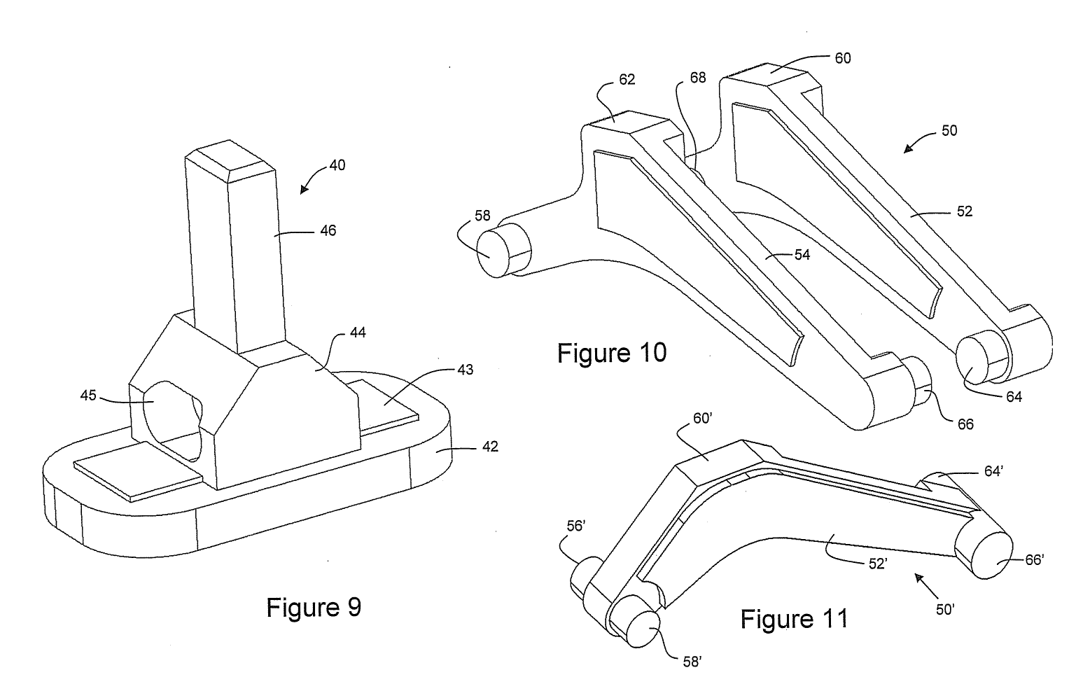

Referring now to FIGS. 4 through 10, it can be seen that a pair of plungers 40 supported on a pair of dome structures 34 in turn supports oppositely facing pivoting actuators 50, 70. A first actuator 50 is arranged such that it pivots about an axis defined by front attachment posts 56, 58 at the front of the housing 20 (the “front” being defined by the positioning of the lip 14 relative to the rest of the actuation button 12), and a second actuator 70 is arranged such that it pivots about an axis defined by rear attachment posts 80, 82. It can be appreciated that the interior of the housing 20 is configured to interface with the attachment posts 56, 58, 80, 82 such that the first and second actuators 50, 70 are capable of pivoting about their respective attachment posts 56, 58, 80, 82 to apply a force to the actuation surfaces 43 and thereby collapse the underlying dome structures 34. As will be explained in greater detail below, movement of the actuation button 12 operates on the actuators 50, 70 to generate the pivoting action discussed above.

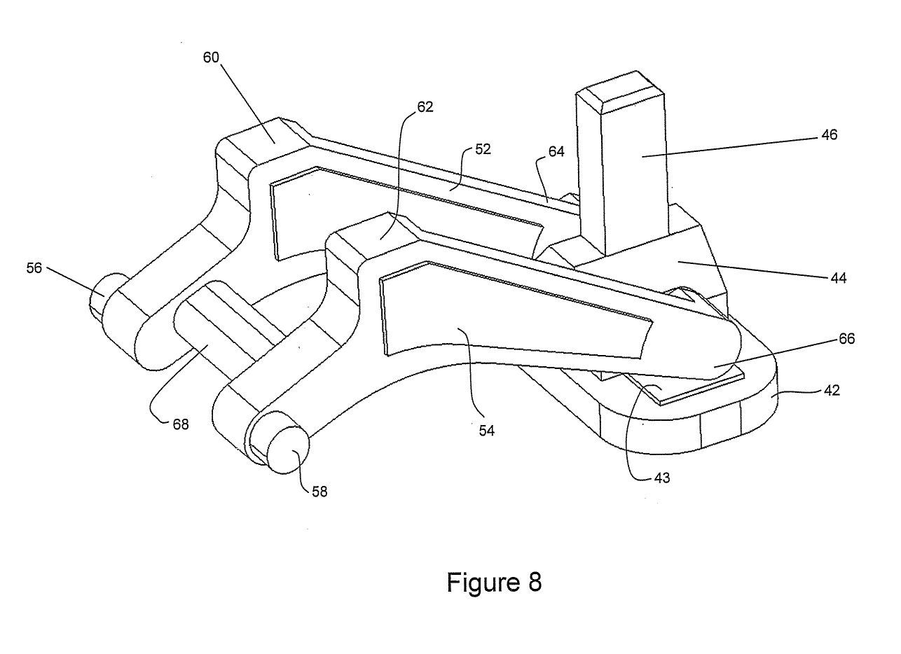

The first actuator 50 comprises a pair of arms 52, 54 separated from each other by a bar 68 extending between the attachment posts 56, 58. The bar 68 is sized to separate the arms 52, 54 such that they accommodate passage of an arm 74 of the second actuator 70 and the guide post 46 of an adjacent plunger 40 therebetween, as best seen in FIG. 4. In this way, the two actuators 50, 70 criss-cross each other in a scissor-like fashion to operate on respective plungers 40 at respective opposite ends of the switch assembly 10 in a compact arrangement. The interaction between the first actuator 50 and its respective plunger 40 is best seen in FIG. 8. The arms 52, 54 extend between the attachment posts 56, 58 and a pair of corresponding actuation members 64, 66. Each of the actuation members 64, 66 protrudes inwardly into the slots 45 on opposite sides of the plunger 40 as shown in FIGS. 5 and 8. The arms 52, 54 also comprise a respective shoulder 60, 62, each shoulder 60, 62 being offset from the attachment posts 56, 58 such that they are aligned with the plunger 40 that corresponds to the second actuator 70 as best seen in FIG. 5. In this way, the reaction force felt by the user upon applying a force to the shoulder 60, 62 is greater than the force that is provided by the dome structure 34 by harnessing the mechanical advantage caused by the lever action and the positioning of the shoulder 60, 62 with respect to the attachment post 56, 58. It can be appreciated that the second actuator 70 is configured to operate under the same principles only for actuating the switch assembly 10 in the opposite direction (i.e. by “pulling” the actuation button 12).

It may be noted that the slots 45 are provided in this example for ease of assembly and would not be required in order for the pivoting actuators 50, 70 to operate. Since the pivoting actuators 50, 70 are configured to be constrained within the housing 20 by the attachment posts 56, 58, the actuator members 64, 66 should only be capable of movement over the actuation surfaces 43 while the guide post 46 ensures linear, vertical movement of the plunger 40 relative to the dome structure 34. Also, the interfaces between the pivoting actuators 50, 70 and the housing 20 can be used to limit fore/aft movements to decrease rattling that can be caused by vibration.

It may also be appreciated that the pivoting actuators 50, 70 as shown in these examples are for illustrative purposes only and variations thereof are possible within the principles described herein. For example, as shown in FIG. 11 a single pivoting actuator 50′ comprising pairs 56′/58′ and 64′/66′ of outwardly extending posts in place of the dual configuration shown in FIG. 10.

Turning now to FIG. 12, the extensions 90, 94 are aligned with the pivoting actuators 50, 70 to actuate a first electrical switching operation and upon further depression, a second electrical switching operation, in each of the two directions. It has been recognized that while typical double dome structures (e.g. the dome structure 34 in this example) may provide this sequential electrical switching operation, they are often limited in the tactile effort values (peak force) available. This is due to the increased size of at least the outer flexible wall that is collapsed in order to perform the first switching operation. In other words, the larger the dome being used, the lower the peak force available and thus the lower the tactile response experienced by the user. As such, double dome structures such as the dome structure 34 herein described have not been used in applications such as automotive window switches or other areas when higher tactile feedback is considered important to the quality and “feel” of the switch. To address this, the geometry of the extensions 90, 94 and the pivoting actuators 50, 70 can be selected to provide a lever mechanism such that the tactile feedback is greater than that of the domes themselves, overcoming one of the major shortfalls associated with using such a relatively larger, double detent dome structure 34. The actuator members 64, 66, 76, 79 of the pivoting actuator arms 52, 54, 72, 74, can be positioned to provide the desired levering effect to control the tactile feel when operating on the pivoting actuators 50, 70. The exact tactile response can be mapped via calculations to the geometry of the pivoting actuators 50, 70 and the extensions 90, 94 as will be explained in greater detail below.

As shown in FIG. 12, the extension 90 comprises an arcuate or rounded tip 92 (as shown) at its distal end to translate a forward rocking or “pushing” movement of the actuation button 12 to a force imparted on the shoulder 62. This force causes the arm 54 to pivot about the attachment post 58 in turn causing the actuation member 66 to move the plunger 40 in a downward direction (constrained by the guide post 46 and housing 20) to collapse the underlying dome structure 34.

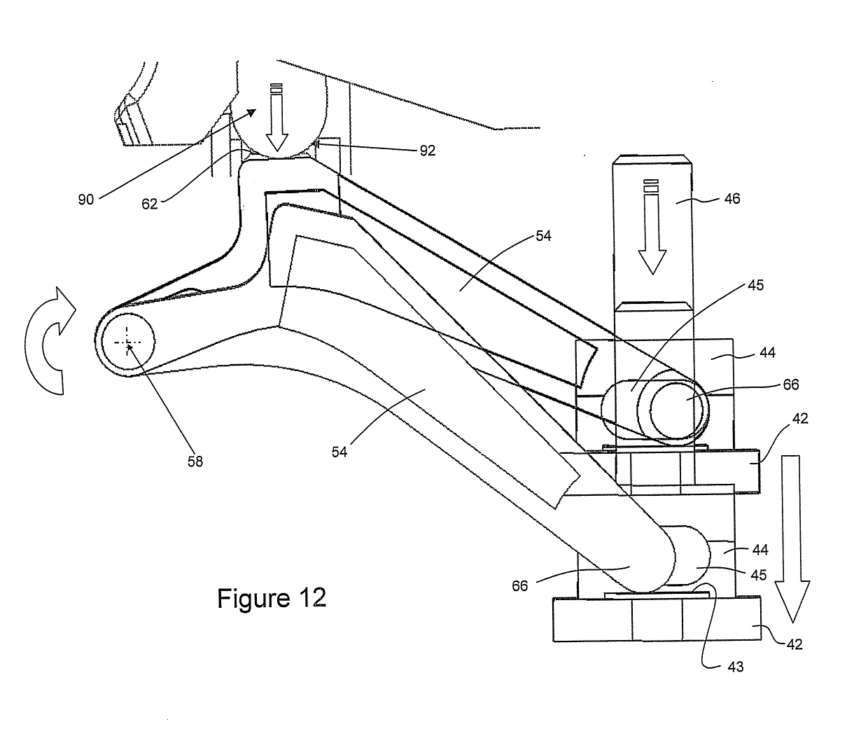

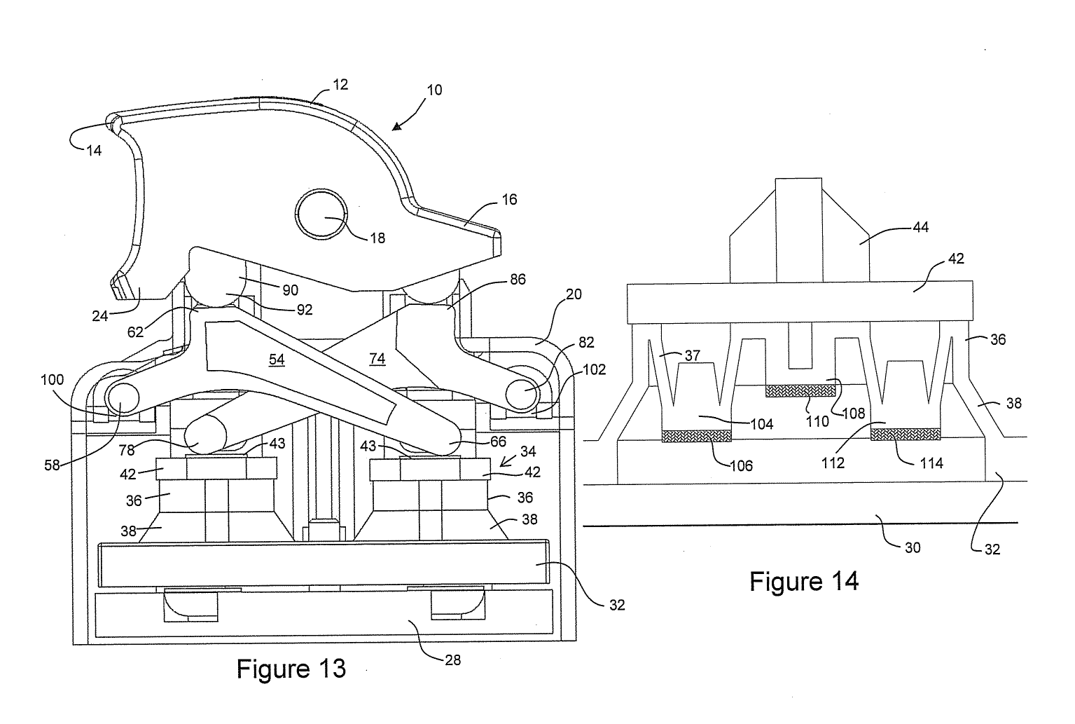

As best seen in FIGS. 13 and 14, at rest, the pivoting actuators 50, 70 are in contact with respective plungers 40, which in turn are in contact with respective domes structures 34, and wherein slight engagement is provided to minimize rattling of the pivoting actuators 50, 70. The slight engagement at rest is often referred to as “preload”. At a defined point of actuation (and depending on the direction of actuation) the corresponding extension 90, 94 applies a force to the corresponding pivoting actuator 50, 70. As seen in FIG. 13, the widths of the extensions 90, 94 are sized such that the rounded tips 92, 96 are in contact with respective shoulders 60, 62, 84, 86 of the pivoting actuators 50, 70 when the switch assembly 10 is in the neutral or “rest” position.

The interior configuration of the dome structure 34 is shown in the cross-sectional view provided in FIG. 14. The dome structure 34 provides a double detent operation by including an inner dome 108 flanked by double outer domes 104, 112 used for a redundant electrical contact in the first detent. The outer domes 104 and 112 are provided for electrical redundancy, but mechanically plural as to provide a planar landing surface (pills on PCB) in order to aid the coaxial and linear collapse of the inner dome 110. Often, 2, 3 or even 4 outer domes 104 are used radially around an inner dome 110. This has the added benefit of more contact opportunities (reliability) and parallel electrical paths (lower contact resistance). The inner dome 108 is offset from the outer domes 104, 112 in the vertical direction such that as the dome structure 34 is collapsed, the outer domes 104, 112 will activate prior to the inner dome 108. The inner dome 108 has a downwardly facing inner contact 110 and the outer domes 104, 112 have respective downwardly facing outer contacts 106, 114. The contacts 110, 106, 114 are aligned with corresponding contacts (not shown) on the upwardly facing surface of the PCB 30.

The outer domes 104, 112 are supported above the PCB 30 in the rest position via the outer flexible wall 38. The inner dome 108 and the plunger base 42 are supported above the PCB 30 via the actuation stage 36. The actuation stage 36 extends from the outer flexible wall 38 and continues back towards the outer domes 106, 112 via a pair of inner flexible walls 107. The actuation stage 36 also comprises a central portion that also continues back towards the inner dome 108 via another pair of inner flexible walls 107.

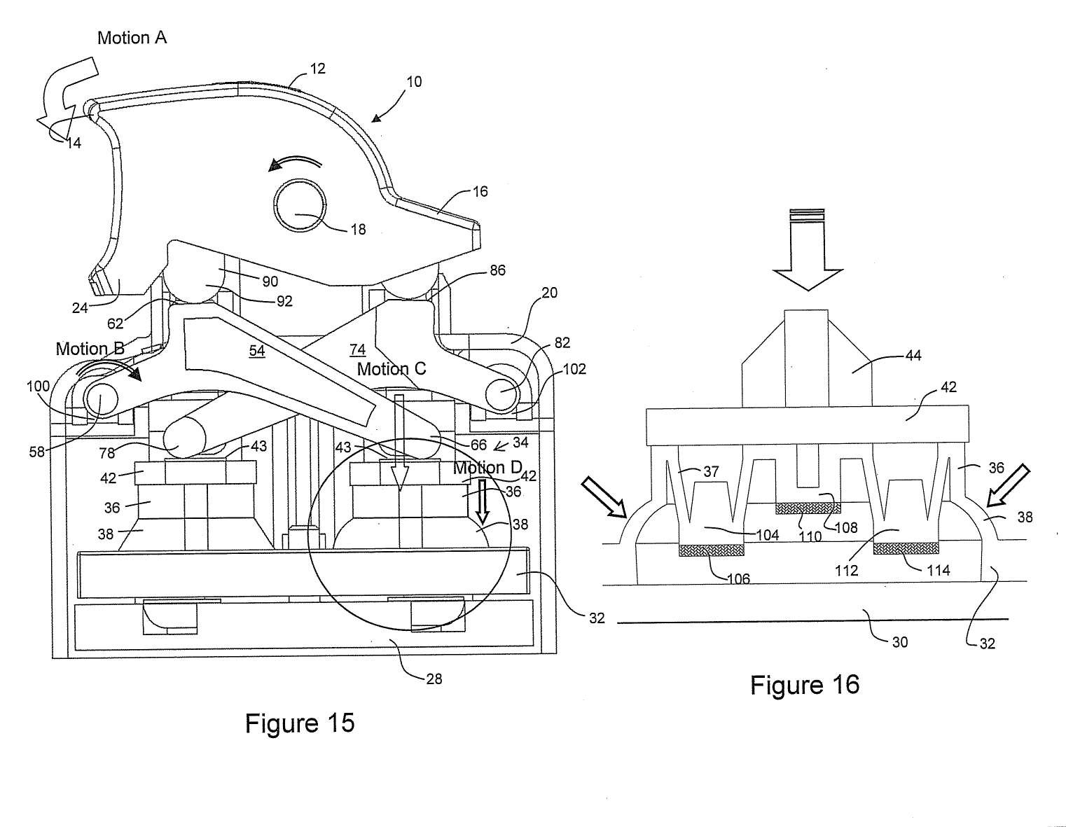

FIGS. 15 and 16 show the interaction between the frontward extension 90 and the shoulder 62 of the first pivoting actuator 50. Motion A shown in FIG. 15 is caused by rotating or “pushing” down on the lip 14 of the actuation button 12. As a result of motion A, the tip 92 moves along an arc to begin moving the pivoting actuator 50 about the attachment posts 56, 58 illustrated as motion B. Motion B causes the actuation member 66 to impart a downward force on the actuation surface 43 of the plunger 40, causing the plunger 40 to move in the downward direction as illustrated by motion C, constrained by the guide post 46. Motion C in turn causes movement D which begins the onset of the dome structure 34 collapsing. FIG. 16 illustrates that the downward force imparted on the dome structure 34 begins to deflect the outer flexible wall 38.

It can be appreciated that when the actuation button 12 is operated on, conjoint movement of the extension 90 causes the pivoting actuator 50 to move down along an arc as defined by a radius equal to its length due to the arrangements of the pivoting actuator 50 and the housing 20.

It can also be appreciated from FIG. 15 that the shoulder 62, the radius of the rounded tip 92, and the distance between the rotation point of the actuation button 12 and the pivoting actuator 50, control the amount of force and travel that the user feels when rotating the actuation button 12. Either the force or rate of dome collapse (actuator travel vs. pivoting actuator down-travel, aka “dome travel”) are affected by changes to the dimensions of these elements, allowing for customized solutions.

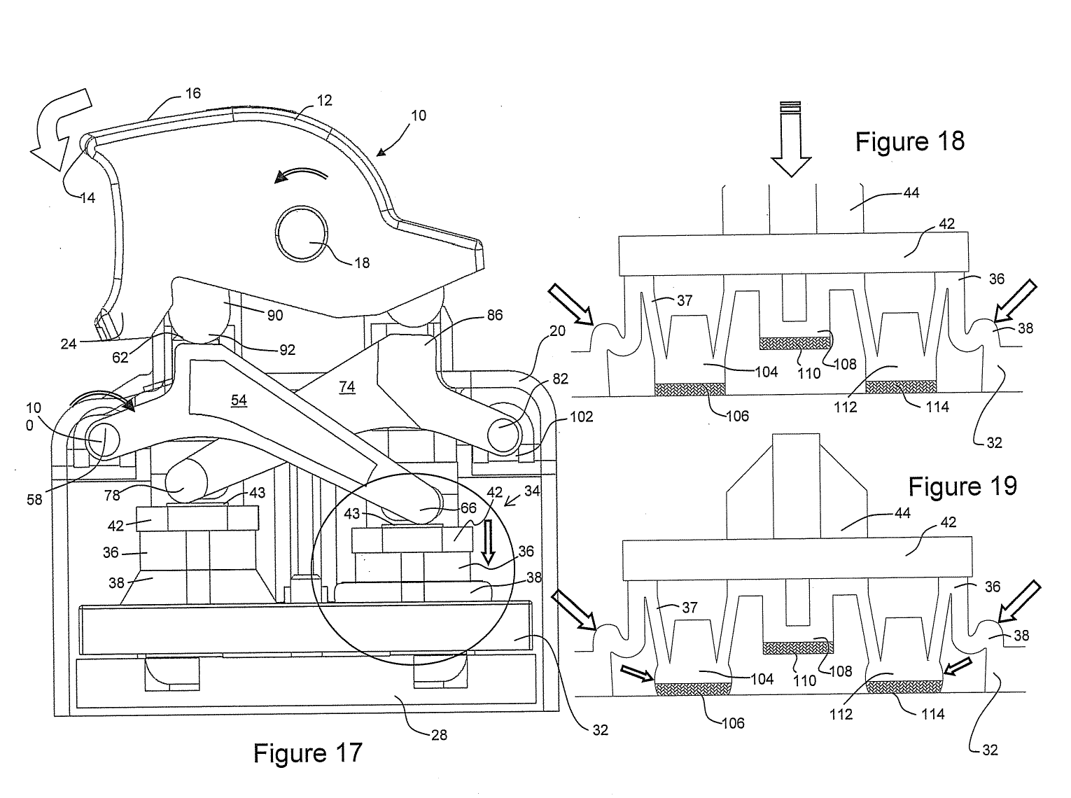

Sequential actuation of the outer domes 104, 112 and the inner dome 108 is shown making reference to FIGS. 17 through 24. Turning first to FIG. 17, it can be seen that the plunger 40 has moved further downward with respect to the view shown in FIG. 15 thus collapsing the outer flexible wall 38 as shown in FIG. 18, which corresponds to the first detent and thus the first position in the corresponding direction for the actuation button 12. This action causes the outer contacts 106, 114 to engage the respective contacts on the PCB 30. In this first stage of the dual-stage activation, the pivoting actuator 50 has been forced in a downward direction causing the actuation member 66 to force the underlying plunger 40 to move in a downward direction and cause the dome structure 34 to collapse. Upon the first electrical contact being made, the first detent is simultaneously felt by the user. Further downward movement of the plunger 40 causes the outer domes 104, 112 to begin to deflect as shown in FIG. 19 which indicates the onset of the second actuation stage.

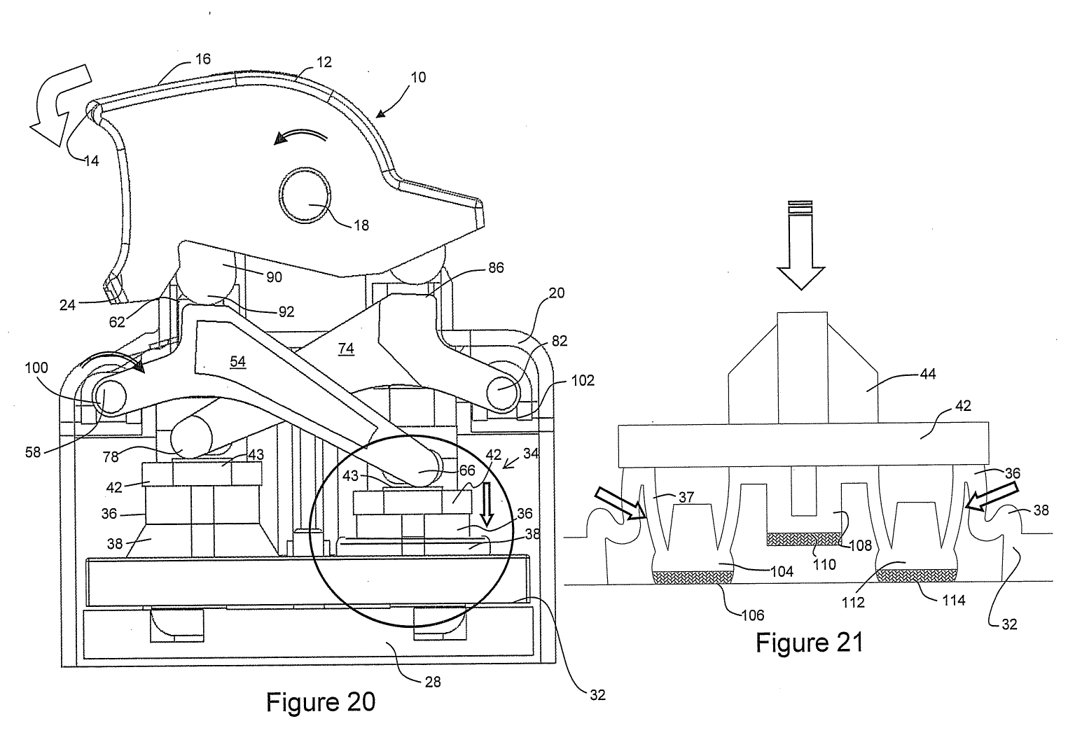

Turning now to FIGS. 20 and 21, as the plunger 40 begins to move beyond the first detent, the inner flexible walls 107 begin to deflect as shown in FIG. 21 indicating the onset of the inner dome 108 collapsing. In this stage, as the force imparted on the actuation stage 42 increases, the mechanical resistance of the dome structure 34 increases. Next, the outer flexible wall 38 moves past the “snap-over point” wherein the mechanical resistance begins to decrease and the distance traveled increases. It may be noted that if the dome structure 34 is forced to further collapse beyond this point, the mechanical resistance increases once again, due to the compressibility of the e-pad material.

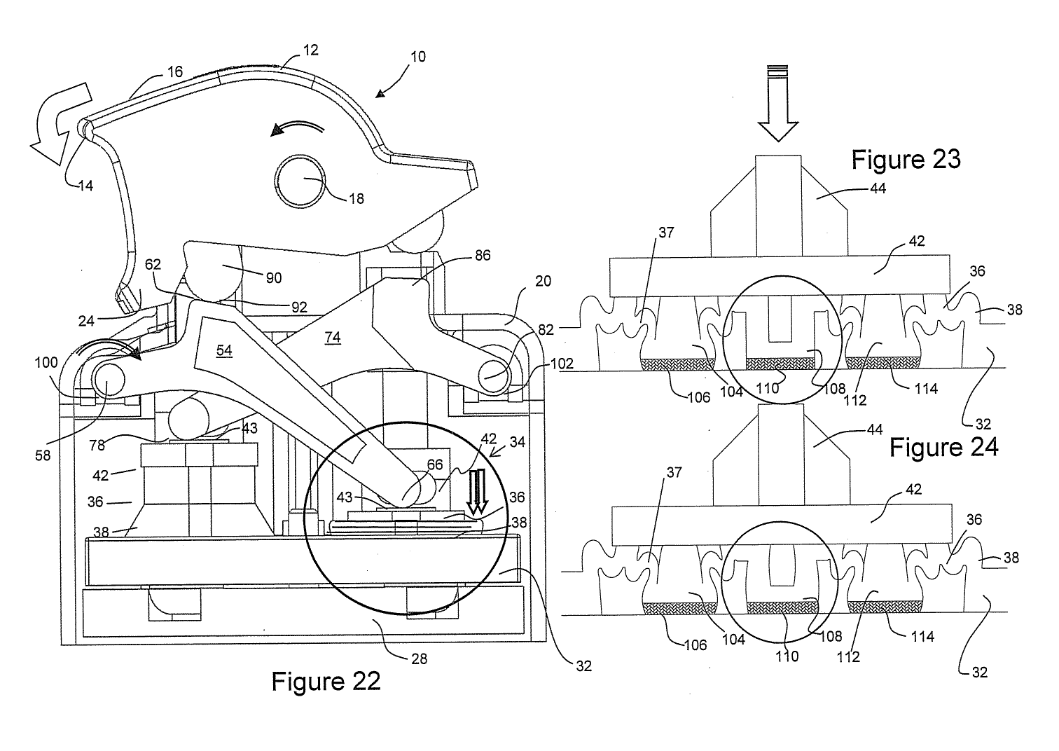

Further movement at this stage, as shown in FIG. 22 causes the inner flexible walls 37 to collapse as shown in FIG. 23 thus collapsing the inner dome 108 and, at the same time, engaging the inner contact 110 with the PCB 30. This action corresponds to the second detent and thus the second position in the corresponding direction for the actuation button 12. At this stage, the second detent is felt by the user. Even further movement of the plunger 40 in the downward direction as shown in FIG. 24 illustrates an over-travel situation wherein both the inner and outer domes 108, 106, 114 continue to compress on themselves with negligible additional movement, marking the end of travel condition.

It can be appreciated from FIGS. 15 to 21 that at the end of travel, the geometry of the pivoting actuator 50 and the radii of the extension tips 92, 96 impart an optimal travel distance to make a reliable electrical contact without adversely affecting the durability of the dome structures 34. Each dome structure 34 is typically designed by e-pad designer who specifies a maximum travel for the dome. A suitable travel has been found to be a distance of 1.4 mm to make the electrical contact and another 0.5 mm beyond that point, for a total of 1.9 mm to be the dome's limit. In this case, the design calculations should ensure that the travel will be more than 1.4 mm and less than 1.9 mm. Because the outer domes 104, 112 are substantially identical in construction, the full travel for the secondary contacts should be equal. It may be noted that the dome travel is important to the operability of the overall switch assembly 10, since less than a minimum amount of travel reduces the likelihood of a reliable electrical contact being made whereas greater than a maximum amount of travel can adversely affect the durability of the dome structures 34 such that the dome structures 34 fail prematurely.

It can be appreciated that “pulling” up on the lip 14 of the actuation button 12 causes the same sequence of operations to occur using the rear extension 94, the second pivoting actuator 70, its respective plunger 40, and the front dome structure 34.

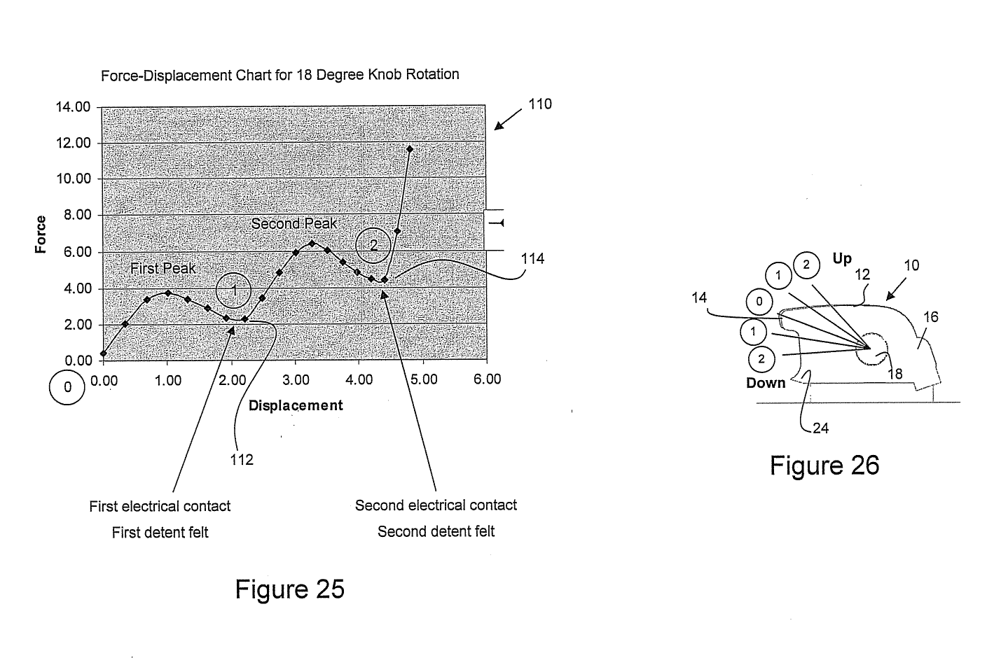

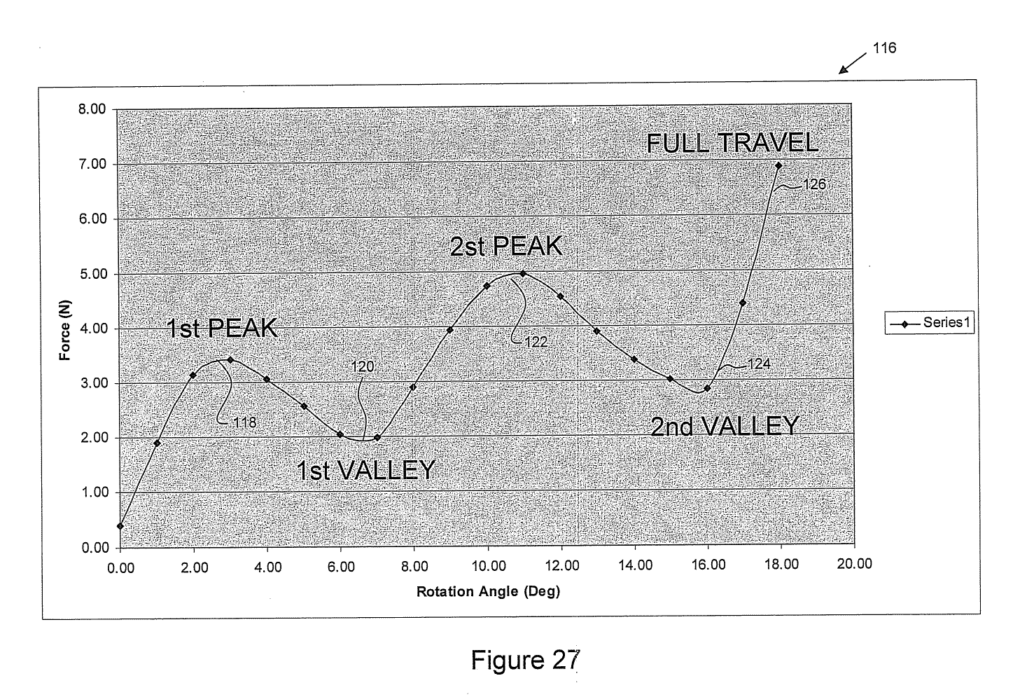

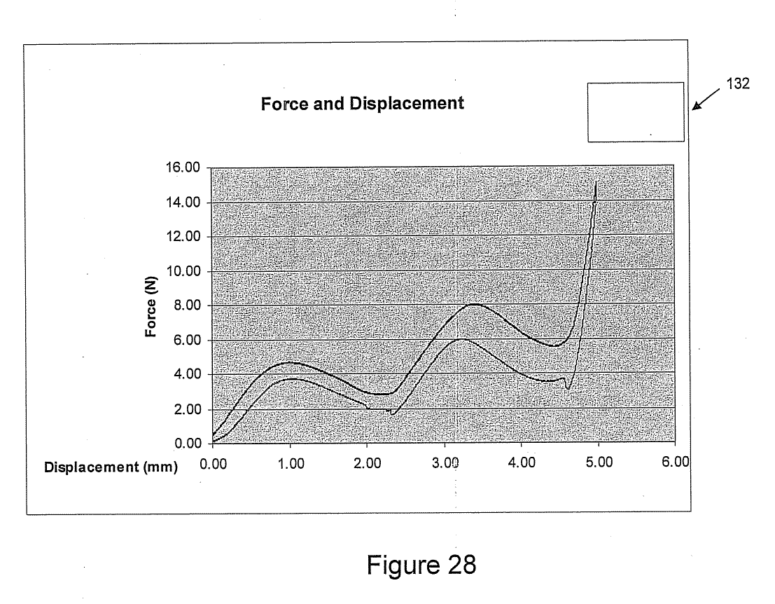

FIGS. 25 through 27 illustrate a force-travel curve for the dome structures 34 shown in FIGS. 13 to 24. E-pads 32 are commonly used in automotive, consumer electronics, communication, computer, medical and various other applications. As such, it can be appreciated that the principles of the pivoting actuator 50, 70 and its sequential operation can be applied beyond automotive applications. It may be noted that in some applications, various versions of the same switch assembly 10 are needed. For example, the same switch assembly 10 may be desired for applications wherein the secondary function is desired and others wherein the secondary function is not desired. Using the configuration described herein, all that is needed to add or remove secondary functions in either direction of actuation, is the addition or removal of a travel limiting feature on the actuation button 12 and/or housing 20, so as to preclude the additional movement that collapses the second dome 108. This provides various combinations of single or double detent feels in the respective directions. For example, FIGS. 25 to 27 illustrate a force-angle graph for a two-stage actuation which is applicable to both directions if both pivoting actuators 50, 70 are used. The force-angle graphs in FIGS. 28 and 33 illustrate that the down direction in this example has two distinct detents whereas the up direction experiences only one detent.

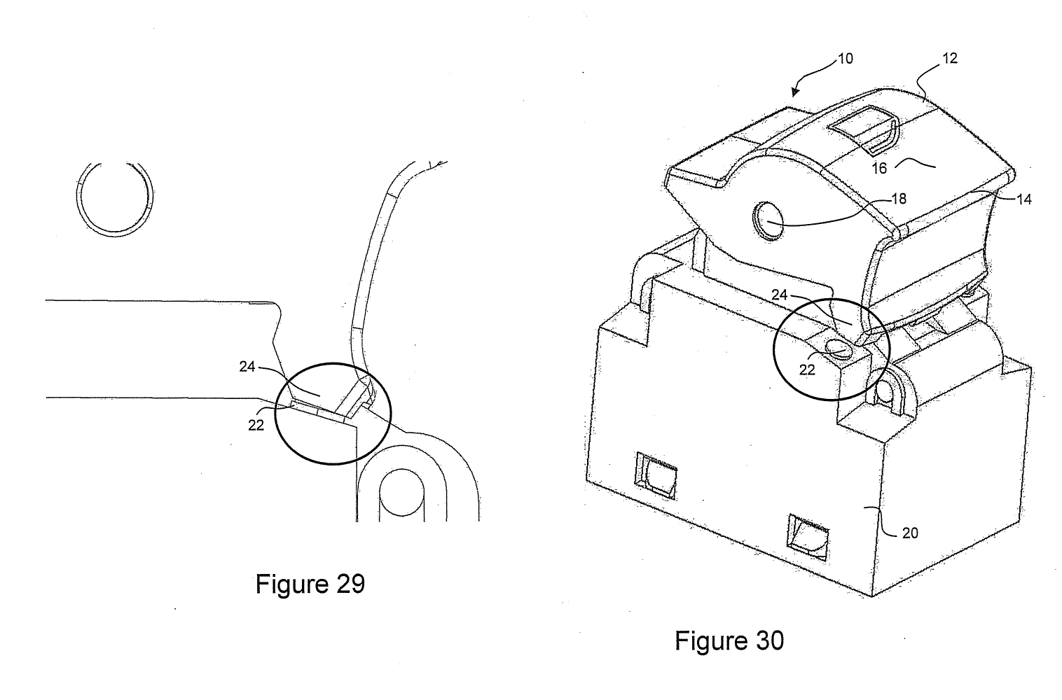

Therefore, the configuration described herein offers the flexibility to produce a “family” of switch assemblies 10 since it can be easily arranged to provide 2, 3, or 4 electrical functions. The combinations listed in Table 1 below are achieved by adding or removing one or both of the pivoting actuators 50, 70 and introducing an actuator travel limiting feature 22, 24 during molding of the actuation button 12 and/or housing 20 as shown in FIGS. 29 and 30. In this way, a single, unidirectional combination can be achieved by incorporating a limiter (not shown) to limit actuator movement in one direction or the other.

TABLE 1
Switch Family Combinations

| Combination | Description | Configuration |
|---|---|---|
| 1a | One down function | Front pivoting actuator |
| | only | for forward movement |
| | | and limiter for |
| | | rearward movement |
| 1b | One up function | Rear pivoting actuator |
| | only | for rearward movement and |
| | | limiter for forward movement |
| 2a | One down function | Both pivoting actuators and one |
| | and two up functions | limiter for rearward movement |
| 2b | One up function and | Both pivoting actuators and one |
| | two down functions | limiter for forward movement |
| 3 | One up function and | Both pivoting actuators |
| | one down function | with limiters for forward and |
| | | rearward movement |
| 4 | Two up functions and | All four pivoting |
| | two down functions | actuators, no limiters |

Using the above-described electrical switch assembly 10, the overall tactile response of the assembly 10 can be customized to complement the tactile profile of the e-pad 32, therefore eliminating the need to change the e-pad 32 to provide different tactile profiles. By changing the geometry of the pivoting actuators 50, 70 and extensions 90, 94, the amount of force for each detent can be adjusted to suit a particular application, which enables a wide range of forces to be achieved using variations in such geometry. Moreover, the travel-to-actuation for each switching stage can be adjusted, which corresponds to the number of degrees of rotation or millimetres of linear travel required to reach the first and second detents. This flexibility is provided with changes only to the geometry of the pivoting actuator 50, 70 and the actuation button 12, independent of the e-pad 32. This is particularly advantageous since typically the travel and force ranges available for a given dome structure 34 are limited. Also, changing the characteristics of the e-pad 32 such as force and travel can typically only be done by changing the entire geometry, which is time consuming and expensive and the results of which are not fully predictable and thus require verification through testing. The durability of the e-pad 32 may be affected by any such changes and thus a full durability test would also be required after each change to the e-pad 32 which is undesirable. Therefore, providing the ability to change the tactile feel of an electrical switch assembly 10 without these considerations is considerably desirable.

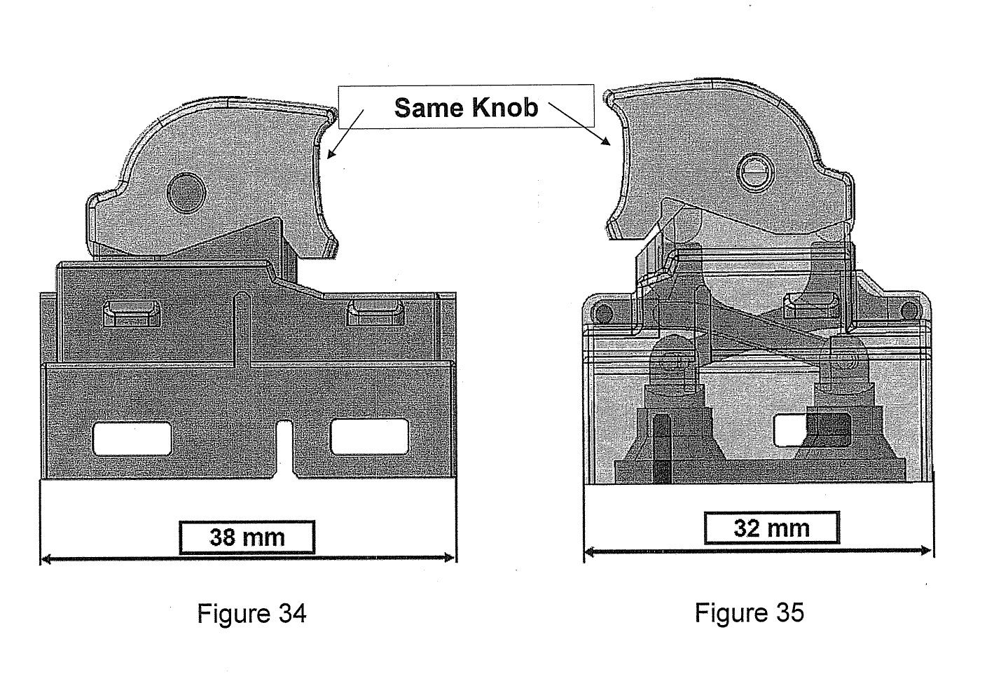

The durability and reliability of the domes structures 34 are also maintained using the configuration described herein by using the constrained linear motion of the plungers 40 as illustrated in FIG. 8, protecting the dome structures 34 from non-axial operation, which can occur with the traditional designs discussed earlier. Furthermore, the travel of the domes (71, 81) can be optimized by changing the geometry of the components (discussed above) to maximize the life of the e-pad 32. The package size for the configurations exemplified herein can be made relatively small. For example, it has been found that the assembly 10 shown in FIG. 2 can be produced with overall dimensions of 26 mm (L)×23 mm (W)×34 mm (H). However, it can be appreciated that even smaller package sizes can be achieved. To illustrate the effect on the package size of using the pivoting actuators 50, 70, FIGS. 34 and 35 shown an overall length reduced from 38 mm to 32 mm respectively by using the pivoting actuators 50, 70, even using the same actuator button or “knob”.

The minimal number of components and simple layout of the electrical switch assembly 10 herein described can contribute to a less expensive product that can be manufactured more easily while minimizing resultant manufacturing errors. The configuration and the assembly 10 shown in FIG. 3 can be manufactured using low volume/manual environments or high volume/automated environments.

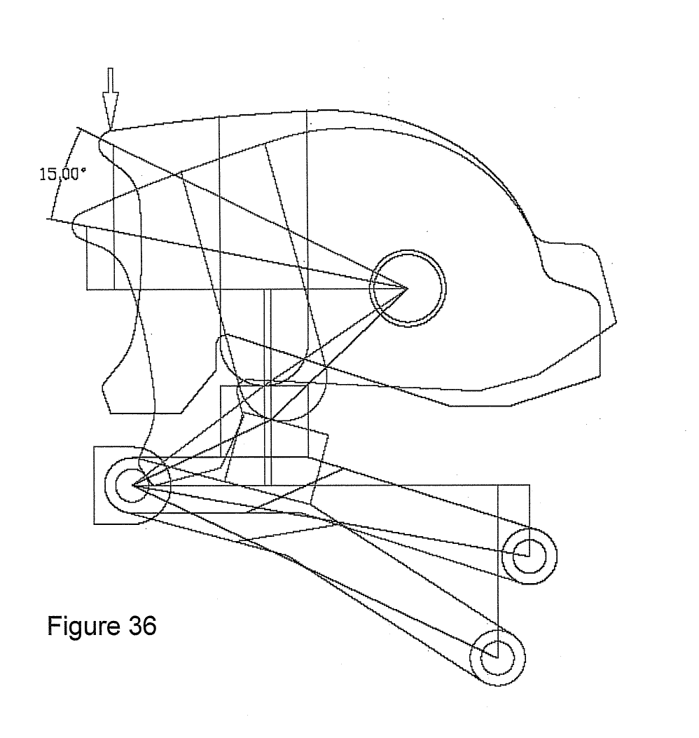

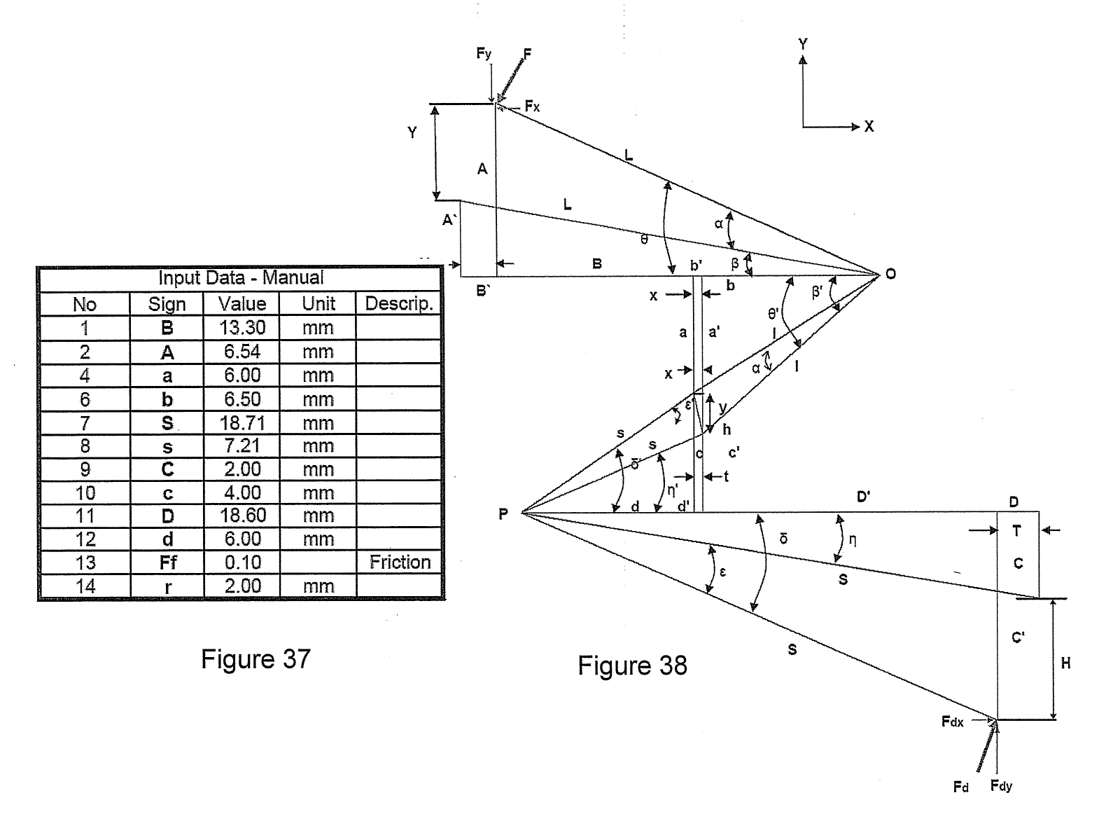

FIGS. 36 to 40 illustrate an example calculation of the force multiplier effects as follows:

0: Initial angle (Rad) = ACOS((B/L))
β: Current angle (Rad) = θ − α
A′: Height after α° rotation = L*SINβ
B′: Length after α° rotation = L*COS(β)
X: Knob horizontal travel = B′ − B
Y: Knob vertical travel = A − A′
θ′: Initial angle (Rad) = ATAN((a/b))
β′: Current angle (Rad) = α + θ′
a′: Height after α° rotation = l*SIN(β′)
b′: Length after α° rotation = l*COS(β′)
δx: Correction factor − Knob = r*SIN(α)
δy: Correction factor − Knob = r − r*COS(α)
δx′: Correction factor − Actuator = 2*r*SIN(α/2)*SIN((Pl − α)/2)
δy′: Correction factor − Actuator = 2*r*SIN(α/2)*COS((Pl − α)/2)
x: Knob − Actuator horizontal travel = D − b′ − δx − δx′
y: Knob − Actuator vertical travel = a′ − a + δy − δy
c′: Actuator − Knob height = c − y
d′: Actuator − Knob horizontal = SQRT((s\hat{ }2 − c′\hat{ }2))
s′: According to carrection factore = SQRT((c′ + δy′)\hat{ }2 + (d′ − δx′)\hat{ }2)
η″: Initial plunger rotation (Rad) = ASIN((c − y)/s)
δ′: Initial angle (Rad) = ASIN(c/s)
η′: Current angle (Rad) = ASIN(c′/s′)
ε′: Travel angle (Rad) = (δ′ − η′)*Pl/180
t: Actuator − Knob x − displac. = d′ − d
ε: Actuator travel angle (Rad) = δ′ − η″
η: Current plunger angle (Rad) = ASIN(C/S)
δ: Initial plunger angle (Rad) = η + ε
C′: Plunger height = S* SIN(δ)
D′: Plunger horizon. Length = S*COS(δ)
T: Plunger x − travel = D − D′

Force Calculations

Fdy: Dome force vertical = Fd*COS(δ)
Fdx: Dome force horizontal = Fd*SIN(δ)
Fp: Plunger force from knob = (Fdy*D′ + (Fdx − Ff)*C′)/s
Fpy: Plunger force − vertical = Fp*COS(η′)
Fpx: Plunger force − horizontal = Fp*SIN(η′)
Fn: Knob actuator force = Fpy
Fny: Knob actuator force − vertical = Fn*COS(ε′)
Fnx: Knob actuator force − horizon = Fn*SIN(ε′)
Fy: Knob force vertical force = F*COS(β)
Fx: Knob force horizontal force = F*SIN(β)
Ff: Friction Force = 0.10

Mechanism Output

H: Travel or Stroke (mm) = C′ − C
Fd: Epad dome force (N) = Force Input
F: Knob force (N) = (Fny*COS(ε)*b′ − (Fnx*SIN(ε) − Ff*Fnx*SIN(ε))*a′)/L

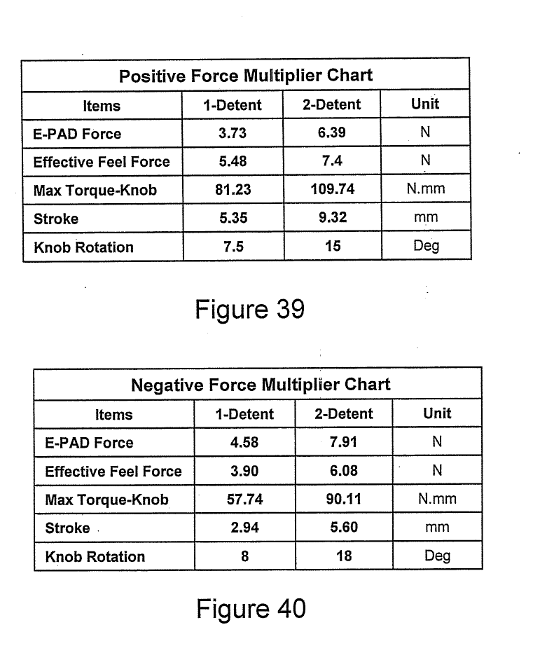

FIGS. 39 and 40 illustrate results with two example sets of inputs to the above calculations.

Unlike other e-pad-based switch assemblies (not shown), the switch assembly 10 shown herein uses leverage from a part nearly as long as the housing 20 to reduce the arcing motion, creating a nearly linear movement over a short distance. The lever offers a mechanical disadvantage as to higher efforts reflected back to the user increasing the resultant force on the knob than is generated by the e-pad 32 alone and enabling the actuation button 12 to have a larger range of travel as shown in FIGS. 13 through 24, all while offering these advantages in a relatively small package. The direction of the forces contributes to a more accurate operation because the pivoting actuators 50, 70 are constrained in their pivot sockets in the housing 20 and lateral attachment posts 56, 58, 76, 78. Therefore, only a few dimensions on the pivoting actuators 50, 70 and the corresponding surfaces of the housing 20 need to be controlled to get better performance uniformity across a large number of manufactured parts. In total, fewer dimensions need to be controlled to produce a desired product and achieve desirable manufacturing yields.

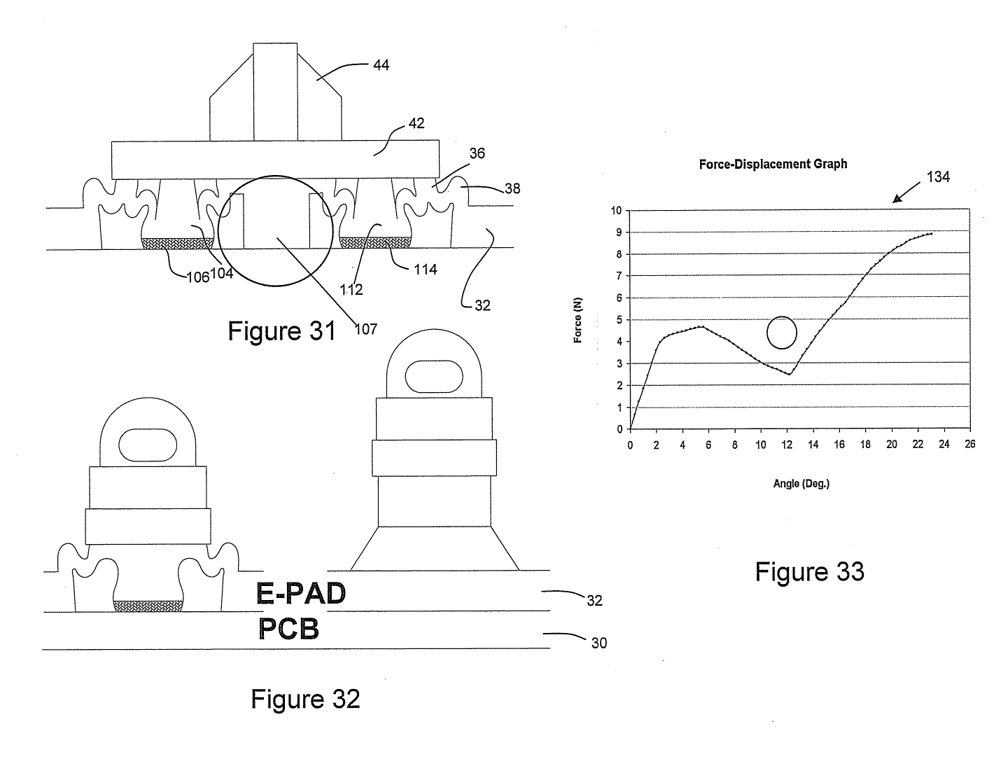

FIGS. 31 and 32 show the replacement of the inner dome 108 and its contact 110 in order to preclude the travel and collapsing effect of the second detent, rather than removing the pivoting actuators. The “dummy” dome 107 is used to create the leverage effects for the first detent and travel profile and, as such, these figures show how to maintain that part of the tactile profile curve and eliminate the force and travel aspects of the second detent.

It can be appreciated that spring-based switch cells could be used if desired despite the tactile response that they generate being different from single and dual stage e-pads (i.e. does not produce peaks and valleys as per FIG. 25). In cases where, due to package size or residual forces at rest, a lighter spring is inherent or chosen, while the efforts of a stiffer spring effect are needed, the pivoting actuator 50, 70, with its levering ratio effect can still be deployed as a force multiplier.

Although the above principles have been described with reference to certain specific embodiments, various modifications thereof will be apparent to those skilled in the art without departing from the scope of the claims appended hereto.

1. An electrical switch assembly comprising:
a housing;
an actuation button supported by the housing, the actuation button having a first downward extension;
an electrical circuit contained in the housing;
an elastomeric pad comprising a collapsible dome overlying the electrical circuit; and
a first pivoting actuator supported in the housing between the first downward extension and the dome, the first pivoting actuator comprising a first end pivotally connected to the housing, a second end aligned with an upper surface of the dome, and a shoulder between the first and second ends and aligned with the first downward extension to be operated on by the first downward extension during a first movement of the actuation button to cause the second end of the first pivoting actuator to collapse the first dome to activate the electrical circuit.

2. The electrical switch assembly of claim 1, wherein the first downward extension comprises a rounded tip to interface with the shoulder.

3. The electrical switch assembly of claim 1, wherein the collapsible dome is a double detent dome.

4. The electrical switch assembly of claim 1, further comprising a first plunger interposed between the second end and the dome, the first plunger comprising an actuation surface for interfacing with the second end.

5. The electrical switch assembly of claim 4, wherein the first plunger comprises a slot for receiving a protrusion extending from the second end to guide movement of the second end during a pivotal movement of the first pivoting actuator.

6. The electrical switch assembly of claim 4, wherein the first plunger comprises an upwardly extending guide post to restrict lateral movement of the first plunger relative to the first collapsible dome.

7. The electrical switch assembly of claim 1, wherein the shoulder is located closer to the first end than the second end.

8. The electrical switch assembly of claim 1, further comprising a travel limiting element to restrict movement of the actuator button.

9. The electrical switch assembly of claim 1, further comprising a second pivoting actuator supported in the housing between a second downward extension of the actuation button and a second collapsible dome spaced from the first collapsible dome, the second pivoting actuator comprising a first end pivotally connected to the housing, a second end aligned with an upper surface of the second collapsible dome, and a shoulder between the first and second ends of the second pivoting actuator and aligned with the second downward extension to be operated on by the second downward extension during a second movement of the actuation button to cause the second end of the second pivoting actuator to collapse the second dome to activate the electrical circuit.

10. The electrical switch assembly of claim 9, wherein the first and second pivoting actuators are pivotally supported at opposite ends of the housing and cross each other to operate on oppositely placed first and second domes.

11. The electrical switch assembly of claim 9, further comprising a second plunger interposed between the second end of the second pivoting actuator and the second dome, the second plunger comprising an actuation surface for interfacing with the second end of the second pivoting actuator.

12. The electrical switch assembly of claim 11, wherein the second plunger comprises a slot for receiving a protrusion extending from the second end of the second pivoting actuator to guide movement of the second end of the second pivoting actuator during a pivotal movement of the second pivoting actuator.

13. The electrical switch assembly of claim 11, wherein the second plunger comprises an upwardly extending guide post to restrict lateral movement of the second plunger relative to the second collapsible dome.

14. A pivoting actuator for actuating a collapsible dome in an electrical switch assembly, the pivoting actuator comprising:
at least one attachment post at a first end for pivotally connecting the pivoting actuator to a housing of the electrical switch assembly;
a first arm extending from the at least one attachment post to a second end aligned with an upper surface of the dome; and
a shoulder between the first and second ends and aligned with a first downward extension from an actuation button of the electrical switch assembly to be operated on by the first downward extension during a first movement of the actuation button to cause the second end of the pivoting actuator to collapse the dome and activate the electrical circuit.

15. The pivoting actuator of claim 14, further comprising a plunger to be interposed between the second end and the dome, the plunger comprising an actuation surface for interfacing with the second end.

16. The pivoting actuator of claim 15, wherein the plunger comprises a slot for receiving a protrusion extending from the second end to guide movement of the second end during a pivotal movement of the pivoting actuator.

17. The pivoting actuator of claim 15, wherein the plunger comprises an upwardly extending guide post to restrict lateral movement of the plunger relative to the dome.

18. The pivoting actuator of claim 14, wherein the shoulder is located closer to the first end than the second end.

19. The pivoting actuator of claim 14, wherein the second end of the first arm interfaces with a first portion of the upper surface of the dome, and the pivoting actuator further comprising a second arm extending from the at least one attachment post to a second end aligned with a second portion of the upper surface of the dome.

20. The pivoting actuator of claim 14, wherein the dome is a double detent dome.
